(19) United States
(12) Patent Application Publication
(10) Pub. No.: US 2024/0194945 A1
(43) Pub. Date: Jun. 13, 2024

(54) ORGANIC-INORGANIC COMPOSITE ELECTROLYTE AND PREPARATION METHOD THEREOF AND BATTERY

(71) Applicants: HON HAI PRECISION INDUSTRY CO., LTD., New Taipei (TW); SolidEdge Solution Inc., Hsinchu (TW)

(72) Inventors: MAO-SUNG CHEN, Hsinchu (TW); Hong-Zheng Lai, Hsinchu (TW); Tseng-Lung Chang, Hsinchu (TW)

(21) Appl. No.: 18/530,652

(22) Filed: Dec. 6, 2023

(30) Foreign Application Priority Data
Dec. 9, 2022 (CN) 202211578579.0

(51) Int. Cl. H01M 10/0565; H01M 10/052; H01M 10/0567; H01M 10/0568

(52) U.S. Cl. CPC H01M 10/0565; H01M 10/052; H01M 10/0567; H01M 10/0568

(57) ABSTRACT

An organic-inorganic composite electrolyte comprises a plurality of metal cations, a plurality of organic polymer groups, a plurality of negatively charged ion groups and a plurality of salt anions. At least part of the plurality of metal cations is combined with the plurality of organic polymer groups, the plurality of negatively charged ion groups and the plurality of salt anions via covalent bonds.

### CROSS-REFERENCE TO RELATED APPLICATIONS

This application claims all benefits under 35 U.S.C. § 119 from the Chinese Patent Application No. 202211578579.0, filed on Dec. 9, 2022, in the China National Intellectual Property Administration, the disclosure of which is incorporated herein by reference.

### FIELD

The disclosure relates to an organic-inorganic composite electrolyte, a preparation method of the organic-inorganic composite electrolyte, and a battery using the organic-inorganic composite electrolyte.

### BACKGROUND

With the popularity of electric vehicles, requirements for endurance are getting higher and higher. Therefore, how to improve the energy density of secondary batteries, such as lithium and sodium-ion batteries, has always been a popular research direction. However, among the currently available cations, such as lithium, sodium, magnesium, aluminum and other secondary ion batteries, while improving performance, there will be certain safety hazards. The main reason is that during the initial charge/discharge process (activation process) of the battery, the electrolyte will be consumed and a solid electrolyte interphase (SEI layer) will be formed on the surface of the positive and negative electrodes. SEI can protect the positive and negative electrodes, but as the cycle proceeds, the SEI layer will gradually get thicker, causing the internal resistance of the battery to continue to rise, and side reactions with the electrolyte may occur, and dendrite deposition may even occur, which may cause safety hazards.

An ideal electrolyte (solid, gel or colloidal) needs to meet conditions such as high stability under electrochemical and chemical conditions, reduced side reactions, high ionic conductivity and good electronic insulation, and can inhibit electrolysis during the cycle. Lithium dendrites, and because of the decay that occurs during the process.

Because the traditional carbonate electrolyte mainly contains hydrocarbon groups or alkyl groups, the cationic elements of the positive electrode (Fe, Ni, Co, Mn) are easy to dissolve during the circulation process, causing safety hazards. At the same time, high-voltage cathode materials cannot cycle stably due to the limitation of the electrolyte's electrochemical window. They are prone to side reactions at high potentials and large current densities, or have defects such as poor cycle performance and poor rate performance of the battery. To this end, Tesla scholar Jeff Dahn developed compounds such as vinylene carbonate (VC), vinyl sulfate (Ethylene Sulfate, DTD), 3-methyl-1,4,2-diethazole-5-ketone (3-methyl-1, 4, 2-dioxazol-5-one, MDO), lithium difluorophosphate (LiPO₂F₂, LFO) and other additives, but they are also prone to losing electrons and oxidative decomposition under acidic conditions, causing cycles decline.

Ionic liquid (IL) type electrolytes, imidazoles, have low viscosity and high ionic conductivity. The disadvantage is that the electrochemical window is narrow and cannot form a stable Stokes radius (Stoke Radius) with positive ions (Li⁺, Na⁺, K⁺, Mg²⁺, Al³⁺) Quaternary ammonium salts can freely adjust the hydrophilicity or hydrophobicity. The disadvantages are that the viscosity is too high, which drags down the diffusion rate of ions, and the ionic conductivity is too low, which affects the rate performance. Piridines have a wide electrochemical window and high ionic conductivity, but the disadvantage is high viscosity. In addition to the high cost and the above-mentioned shortcomings in the application of ionic liquids, the doping and mixing of different ionic liquids and the complicated process conditions can easily cause counter-effects and cannot be directly blended.

### BRIEF DESCRIPTION OF THE DRAWINGS

In order to illustrate the technical solutions of the embodiments of the present application more clearly, the accompanying drawings in the embodiments will be briefly introduced below. It should be understood that the following drawings only show some embodiments of the present application, and therefore should not be seen as limiting the scope. For one of ordinary skill in the art, other related drawings can also be obtained from these drawings without any creative work.

FIG. 1 is a schematic diagram of a ligand format of the organic-inorganic composite electrolyte provided by the embodiment of the present disclosure.

FIG. 2 is a schematic structural diagram of a negative electrode-less battery provided by an embodiment of the present disclosure.

FIG. 3 is a schematic structural diagram of the negative electrode in the battery without negative electrode provided by the embodiment of the present disclosure.

FIG. 4 is a charge and discharge curve of a battery without anode provided by an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to be considered as limiting the scope of the embodiments described herein.

The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

Embodiments of the present disclosure provide an organic-inorganic composite electrolyte. The organic-inorganic composite electrolyte is formed by reacting at least one ether, at least one nitrile and at least one sulfone with salts and a negatively charged ion agent. The ether is at least one selected from the group consisting of ethylene glycol dimethyl ether, diethylene glycol dimethyl ether, triethylene glycol dimethyl ether and tetraethylene glycol dimethyl ether. The nitrile is at least one selected from the group consisting of acetonitrile, succinonitrile, adiponitrile and glutaronitrile. The sulfone is at least one of sulfolane, sulfone fluoride, succinate and ethyl methyl sulfone. The salts contain at least one anion of ClO₄⁻, AsF₆⁻, PF₆⁻, TFSI (N(CF₃SO₂)₂⁻), FSI(N(FSO₂)₂⁻), BOB(B(C₂O₄)₂⁻), and DFOB(B(C₂O₄)₂⁻), and contain at least one of the cation of Li⁺, Na⁺, K⁺, Mg²⁺, and Al³⁺. The negatively charged ion agent is at least one selected from HNO₃, KNO₃, AgNO₃, C₂N₄O₆, lithium difluorodioxalate, phosphoric acid, Ag₃PO₄, Li₃PO₄, Li₂SO₄, Li₂SO₃, and lithium metabisulfite. The reactants used to form the organic-inorganic composite electrolyte are not limited thereto, as long as they include at least one ether, at least one nitrile, and at least one sulfone, salts, and a negatively charged ion agent.

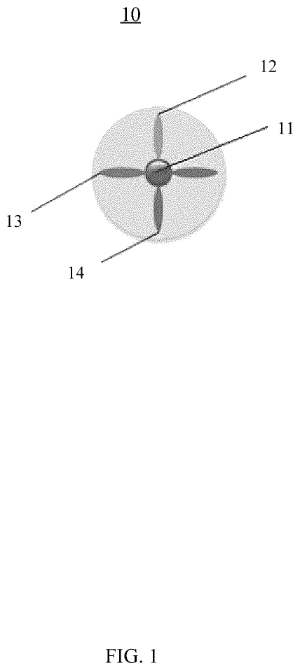

Referring to FIG. 1, which is a schematic format diagram of the ligand (interface model) of the organic-inorganic composite electrolyte 10. The organic-inorganic composite electrolyte 10 includes a plurality of metal cations 11, a plurality of organic polymer chains or groups 12, a plurality of negatively charged ion groups 13 and a plurality of salt anions 14. Among them, at least part of the metal cations 11 are simultaneously combined with the negatively charged ion groups 13, the organic polymer chains 12 and the salt anions 14 through covalent bonds. The salt anions 14 are ClO₄⁻, AsF₆⁻, PF₆⁻, TFSI (N(CF₃SO₂)₂⁻), FSI(N(FSO₂)₂⁻), BOB(B(C₂O₄)₂⁻), DFOB(B(C₂O₄)₂⁻). The metal cation 11 is at least one of Li⁺, Na⁺, K⁺, Mg²⁺, and Al³⁺. The negatively charged ion group 13 is at least one of HNO₃, KNO₃, AgNO₃, C₂N₄O₆, lithium difluorodioxalate, phosphoric acid, Ag₃PO₄, Li₃PO₄, Li₂SO₄, Li₂SO₃, and lithium metabisulfite.

It can be understood that another part of the metal cations is not limited to be combined with the negatively charged ion group, the organic polymer chain or group, and the salt anion at the same time. The part of metal cations can only be combined with one of two of the negatively charged ion group, the organic polymer chain and the salt anion.

Salt anions are configured to provide ionic conductivity, negatively charged coordination ion agents are used as surface stabilizers, and organic molecular compounds are configured to support the Stokes radius, allowing cations (Li⁺, Na⁺, K⁺, Mg²⁺, Al³⁺) to diffuse in the environment, which make the electrons to complete the charge and discharge cycle. The added organic molecular compound can form a film adsorption at the positive electrode interface, inhibit the dissolution of metal ions such as Fe, Ni, Co, Mn, etc., and avoid the formation of metal dendrites on the separator at the negative electrode. In terms of lithium batteries, as an organic-inorganic composite electrolyte, negatively charged coordination ion groups and salt anions form an inorganic SEI, which can inhibit the decomposition of electrolyte side reactions, reduce lithium deposition overpotential, and inhibit dendrites on the surface. Its surface stabilizer can capture H⁺ to inhibit the production of H₂, CH₄, and C₂H₄.

Metal cations connect salt anions and negatively charged ion groups in the form of covalent bonds, while organic polymers facilitate the diffusion of metal cations by providing Stokes radii that support cations. Therefore, the above representation is a dynamic, spherical change. The covalent bond strength between the negatively charged ions and the core metal cation is slightly weaker than that of the salt anion, so it has the ability to capture H⁺ during the charge and discharge process, inhibit the negative reaction of the battery, and stabilize the cycle of charging and discharging.

The organic-inorganic composite electrolyte of this embodiment is a high-voltage, high-safety composite electrolyte. In addition to general wound and soft-packed lithium-ion secondary batteries, it can also be applied to batteries without negative electrodes.

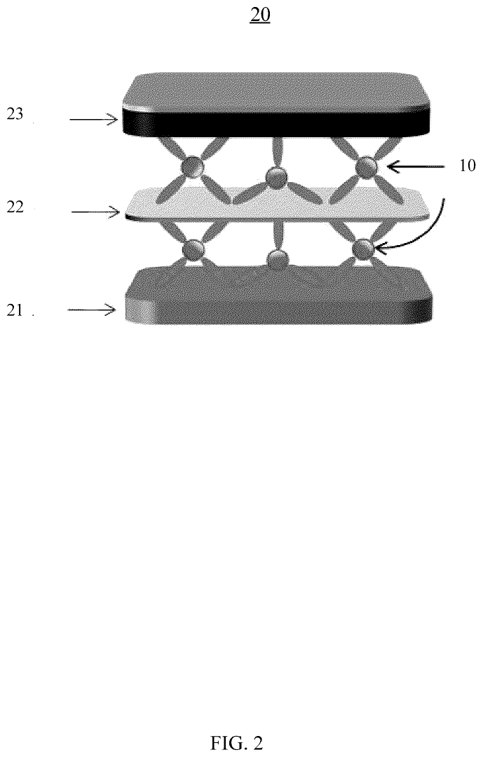

Referring to FIG. 2, an embodiment of the present disclosure provides a battery 20 without anode. The battery 20 comprises a positive electrode 21, a negative electrode 22, a separator 23 disposed between the positive electrode 21 and the negative electrode 22, and an organic-inorganic composite electrolyte 10. The positive electrode 21 is NCM811, the negative electrode 22 is copper foil, and the electrolyte is the organic-inorganic composite electrolyte of the above embodiment. Wherein, at least part of the lithium ions in the organic-inorganic composite electrolyte are simultaneously combined with the negatively charged ion group, the organic polymer chain or group and the salt anion through covalent bonds. Another part of the lithium ions is only combined with one or two of the negatively charged coordination ion groups, the organic polymer chains, and the salt anions at the same time.

It can be understood that the battery is not limited to a battery without anode, and can also be other batteries.

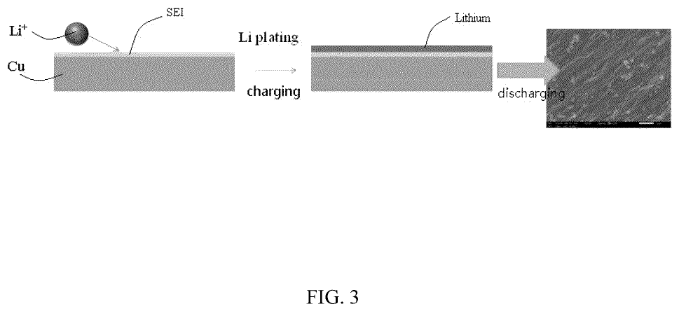

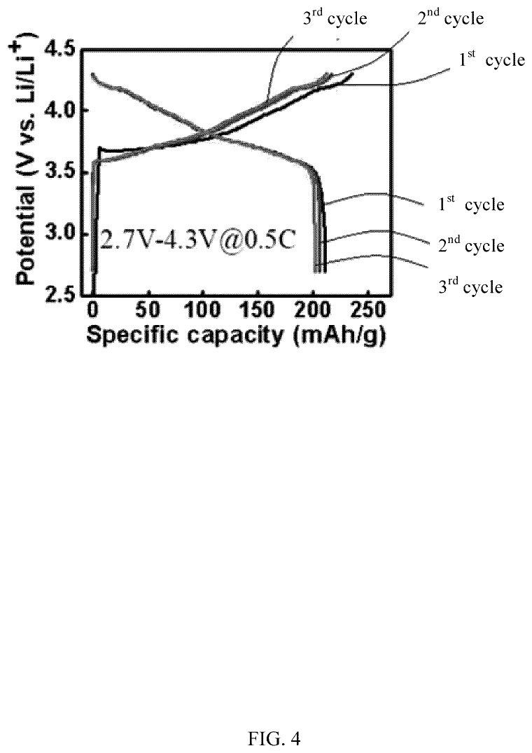

Referring to FIG. 3. on the negative electrode copper foil, the negatively charged ion groups and salt anions in the organic-inorganic composite electrolyte form an inorganic SEI layer, which is thin, dense, and flat. Therefore, there is no dendrite deposition on the negative electrode copper foil. After 200 cycles, there is no agglomeration deposition of lithium metal on the surface, that is, no agglomerated lithium dendrites will be generated, and at the same time, it will not cause corrosion at the current collector end, and there will be no large amount of gas production. Please see FIG. 4 for the electrical test results of the anode-less battery, the anode-less battery has high volumetric energy density, simple manufacturing process and low battery recycling cost.

The embodiment of the present disclosure provides a method for preparing an organic-inorganic composite electrolyte. The preparation method includes the following steps:
S1: mixing at least one ether, at least one nitrile and at least one sulfone to form an organic molecular compound;
S2: mixing at least one salt anion and at least one cation into the organic molecular compound; and
S3: adding at least one negatively charged coordination ion agent for coordination to synthesize an organic-inorganic composite electrolyte.

In step S1, one or more of ethylene glycol dimethyl ether, diethylene glycol dimethyl ether, triethylene glycol dimethyl ether, tetraethylene glycol dimethyl ether, etc.; one or more of dinitrile, adiponitrile, glutaronitrile, etc.; one or more of sulfolane, sulfone fluoride, succinate, ethyl methyl sulfone, etc.; are mixed to from an organic molecular compound. The organic molecular compound includes lowest unoccupied molecular orbital (LUMO) organic molecular groups. For organic molecular compound, the LUMO organic molecular groups, which is the conduction band, needs to be considered. When the energy level difference of the Li⁺ organic molecule is too small, the energy level of LUMO organic molecular groups is too high, and it is easy to lose electrons, affecting stability. Organic groups in the at least one ether, the at least one nitrile or at least one sulfone are LUMO organic molecular groups. As such, organic groups in the organic molecular groups are LUMO organic molecular groups.

In step S1, to avoid reactions during the process, molecular sieves must be used to remove water, and a moisture analyzer must be used to monitor the moisture content <10 ppm. When mixing more than one organic molecular compound, attention needs to be paid to the amount added during blending to avoid excessive heat generation.

In step S1, in one embodiment, diethylene glycol dimethyl ether, succinonitrile, and sulfolane are mixed in a volume ratio of 1:1:1 to form an organic molecular compound.

In step S2, the salt anions contains at least one of ClO₄⁻, AsF₆⁻, PF₆⁻, TFSI (N(CF₃SO₂)₂⁻), FSI(N(FSO₂)₂⁻), BOB(B(C₂O₄)₂⁻), and DFOB(B(C₂O₄)₂⁻). The salt cations contains at least one of cations Li⁺, Na⁺, K⁺, Mg²⁺, and Al³⁺. The concentration of salt cations is in a range of 1-10 mol/L. A temperature of the salt is kept in a range of 0-8° C. to avoid the generation of free acid and cause the ligands to lose balance. Molecular is used to remove water (0.1 ppm).

In one embodiment, PF₆⁻, TFSI (N(CF₃SO₂)₂⁻) and Li⁺ are mixed into organic molecular compounds. Among them, the concentration of Li⁺ is ranged from 1.1 to 1.2 mol/L, and the temperature is controlled at about 2° C.

In step S3, the negatively charged coordination ion agent used for coordination is at least one of HNO₃, KNO₃, AgNO₃, C₂N₄O₆, lithium difluorodioxalate, phosphoric acid, Ag₃PO₄, Li₃PO₄, Li₂SO₄, Li₂SO₃, and lithium metabisulfite. A weight ratio of low LUMO organic molecular groups in the organic molecular compound to the negatively charged coordination ion agent used for coordination is in a range of 0.001-0.100. To avoid generating too much free acid due to heat release, the temperature needs to be controlled at a range of 0-8° C.

In one embodiment, the negatively charged coordination ion agent added for coordination is AgNO₃. Among them, a weight ratio of organic molecular groups to AgNO₃ is 0.05:1, and the temperature is controlled at about 1° C.

At the same time, the functional groups of the organic compounds must be able to form a composite electrolyte with the negatively charged ion agent. The negatively charged coordination ion group and the salt anion form an inorganic SEI, which can inhibit the decomposition of electrolyte side reactions, reduce the lithium deposition overpotential, and inhibit the generation of dendrites on the surface. The production of CO₂, H₂, CH₄, and C₂H₄ is inhibited by capturing H⁺ through negatively charged ions.

The preparation method of the organic-inorganic composite electrolyte in this embodiment directly uses molecular sieves to blend the ligands, and controls the ligand temperature between 0 and 8° C. during the process, which can avoid the degradation of salt anions and the free acid generated by negative reactions (H⁺). The preparation method of the organic-inorganic composite electrolyte in this embodiment has a simple preparation process, is easy to control the process, and is suitable for industrial production. And only molecular sieves are needed for blending, and the electrolyte after blending can be in liquid, colloidal, or condensed state.

Embodiments of the present disclosure provide a method for preparing a battery using an organic-inorganic composite electrolyte. The preparation method includes the following steps: cathode material, conductive agent and binder with a mass percentage of 88:1:11 were dissolved in a solvent to obtain a mixture, and a solid content was controlled at 50%; then a resulting mixture was coated on an aluminum foil current collector and dried under vacuum to obtain a positive electrode sheet.

Based on the designed positive electrode area, design 1.1 times the copper foil current collector as the negative electrode.

Then conventional production processes are used to assemble the ternary cathode plates, organic-inorganic composite electrolytes, and composite separators for soft pack battery stacking and 5Ah assembly.

Batteries using organic-inorganic composite electrolytes in the embodiments of the present disclosure have high volumetric energy density, simple manufacturing processes, and low battery recycling costs.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

Depending on the embodiment, certain of the steps of methods described may be removed, others may be added, and the sequence of steps may be altered. The description and the claims drawn to a method may comprise some indication in reference to certain steps. However, the indication used is only to be viewed for identification purposes and not as a suggestion for ordering the steps.

What is claimed is:

1. An organic-inorganic composite electrolyte, comprising:
a plurality of metal cations, a plurality of organic polymer groups, a plurality of negatively charged ion groups and a plurality of salt anions, wherein at least part of the plurality of metal cations is combined with the plurality of organic polymer groups, the plurality of negatively charged ion groups and the plurality of salt anions via covalent bonds.

2. The organic-inorganic composite electrolyte of claim 1, wherein the plurality of salt anions is selected from the group consisting of ClO₄⁻, AsF₆⁻, PF₆⁻, TFSI (N(CF₃SO₂)₂⁻), FSI (N(FSO₂)₂⁻), BOB(B(C₂O₄)₂⁻), and DFOB(B(C₂O₄)₂⁻).

3. The organic-inorganic composite electrolyte of claim 1, wherein the plurality of metal cations is selected from the group consisting of Li⁺, Na⁺, K⁺, Mg²⁺, and Al³⁺.

4. The organic-inorganic composite electrolyte of claim 1, wherein the plurality of negatively charged ion groups is a negatively charged ion agent.

5. The organic-inorganic composite electrolyte of claim 4, wherein the negatively charged ion agent is selected from the group consisting of HNO₃, KNO₃, AgNO₃, C₂N₄O₆, lithium difluorodioxalate, phosphoric acid, Ag₃PO₄, Li₃PO₄, Li₂SO₄, Li₂SO₃, and lithium metabisulfite.

6. A battery comprising:
a cathode electrode;
an anode electrode; and
an organic-inorganic composite electrolyte comprising:
a plurality of metal cations, a plurality of organic polymer groups, a plurality of negatively charged ion groups and a plurality of salt anions, wherein at least part of the plurality of metal cations is combined with the plurality of organic polymer groups, the plurality of negatively charged ion groups and the plurality of salt anions via covalent bonds.

7. The battery of claim 6, wherein the plurality of salt anions is selected from the group consisting of ClO₄⁻, AsF₆⁻, PF₆⁻, TFSI (N(CF₃SO₂)₂⁻), FSI (N(FSO₂)₂⁻), BOB(B(C₂O₄)₂⁻), and DFOB(B(C₂O₄)₂⁻).

8. The battery of claim 6, wherein the plurality of metal cations is selected from the group consisting of Li⁺, Na⁺, K⁺, Mg²⁺, and Al³⁺.

9. The battery of claim 6, wherein the plurality of negatively charged ion groups is a negatively charged ion agent, and the negatively charged ion agent is selected from the group consisting of HNO₃, KNO₃, AgNO₃, C₂N₄O₆, lithium difluorodioxalate, phosphoric acid, Ag₃PO₄, Li₃PO₄, Li₂SO₄, Li₂SO₃, and lithium metabisulfite.

10. A method for preparing an organic-inorganic composite electrolyte, comprising:
S1: mixing at least one ether, at least one nitrile and at least one sulfone to form an organic molecular compound;
S2: mixing at least one salt anion and at least one cation into the organic molecular compound; and
S3: adding at least one negatively charged coordination ion agent for coordination to synthesize an organic-inorganic composite electrolyte.

11. The method of claim 10, wherein in step S1, a molecular is added to remove water.

12. The method of claim 11, wherein in step S1, a moisture content is less than 10 ppm.

13. The method of claim 10, wherein in step S1, a temperature is in a range of 0-8° C.

14. The method of claim 10, wherein in step S1, the organic molecular compound comprises low LUMO organic molecular groups.

15. The method of claim 14, wherein in step S3, a weight ratio of the LUMO organic molecular groups in the molecular compound to the negatively charged coordination is in a range of 0.001-0.100.

16. The method of claim 10, wherein in step S2, a concentration of the at least one cation in the organic molecular compound is in a range of 1-10 mol/L.

17. The method of claim 10, wherein in step S3, a temperature is in a range of 0-8° C.

18. The method of claim 10, wherein in step S1, the at least one ether is selected from the group consisting of ethylene glycol dimethyl ether, diethylene glycol dimethyl ether, and triethylene glycol dimethyl ether.

19. The method of claim 10, wherein in step S1, the at least one nitrile is selected from the group consisting of acetonitrile, succinonitrile, adiponitrile, and glutaronitrile.

20. The method of claim 10, wherein in step S1, the at least one sulfone is selected from the group consisting of sulfolane, sulfone fluoride, disulfone, and ethyl methyl sulfone.
